(19) United States
(12) Patent Application Publication
(10) Pub. No.: US 2015/0380159 A1
(43) Pub. Date: Dec. 31, 2015

(54) MULTILAYER CERAMIC ELECTRONIC COMPONENT AND METHOD OF MANUFACTURING THE SAME

(71) Applicant: SAMSUNG ELECTRO-MECHANICS CO., LTD., Suwon-Si (KR)

(72) Inventors: Seung Ho LEE, Suwon-Si (KR); Jong Han KIM, Suwon-Si (KR); Min Gon LEE, Suwon-Si (KR); Yoon Hee LEE, Suwon-Si (KR); Sung Hwan LEE, Suwon-Si (KR)

(21) Appl. No.: 14/527,430

(22) Filed: Oct. 29, 2014

(30) Foreign Application Priority Data
Jun. 25, 2014 (KR) 10-2014-0078190

(51) Int. Cl. H01G 4/005; H01G 4/30; H01G 4/12

(52) U.S. Cl. CPC H01G 4/005; H01G 4/12; H01G 4/30

(57) ABSTRACT

A multilayer ceramic electronic component may include a ceramic body including a plurality of dielectric layers, and internal electrodes disposed on the dielectric layer and having an unevenness portion on at least one surface thereof. The unevenness portion includes a plurality of convex portions and a plurality of concave portions alternately disposed, and the convex and concave portions may be formed to extend in a first direction, respectively.

### CROSS-REFERENCE TO RELATED APPLICATION

This application claims the benefit of Korean Patent Application No. 10-2014-0078190 filed on Jun. 25, 2014, with the Korean Intellectual Property Office, the disclosure of which is incorporated herein by reference.

### BACKGROUND

The present disclosure relates to a multilayer ceramic electronic component and a method of manufacturing the same.

Electronic components using a ceramic material, such as capacitors, inductors, and the like, may include a ceramic body formed using the ceramic material, internal electrodes formed in the ceramic body, and external electrodes mounted on a surface of the ceramic body so as to be connected to the internal electrodes.

As various functions in fields requiring high reliability are digitalized and demands therefor are increased, high reliability is also required in the multilayer ceramic electronic component.

As a factor causing a problem in terms of high reliability as described above, there may be crack generation, delamination, a problem related to withstand voltage characteristics, and the like, and residual carbon existing in a ceramic body of the multilayer ceramic electronic component may also have an influence on reliability of multilayer ceramic electronic components. Therefore, in order to improve reliability of multilayer ceramic electronic components, an amount of residual carbon in a ceramic body should be decreased.

### RELATED ART DOCUMENT

Korean Patent No. 10-1069989

### SUMMARY

Some embodiments in the present disclosure may provide a multilayer ceramic electronic component and a method of manufacturing the same.

According to some embodiments in the present disclosure, a multilayer ceramic electronic component may include a ceramic body including a plurality of dielectric layers and internal electrodes disposed on the dielectric layer and having an unevenness portion on at least one surface thereof.

The unevenness portion may include a plurality of convex portions and a plurality of concave portions that are alternately disposed, and the convex and concave portions may be formed to extend in a first direction, respectively.

A difference between average electrode connectivity measured at peaks of the convex portions of the internal electrode and average electrode connectivity measured in troughs of the concave portions of the internal electrode may be 3% to 12%.

According to some embodiments in the present disclosure, a method of manufacturing a multilayer ceramic electronic component may include: preparing a plurality of first green sheets and a plurality of second green sheets; printing an internal electrode pattern having an unevenness portion formed on at least one surface of the internal electrode pattern on the first green sheet; preparing a green sheet multilayer body by stacking the first and second green sheets; and preparing a ceramic body including a plurality of dielectric layers and a plurality of internal electrodes by sintering the green sheet multilayer body, wherein the internal electrode includes a plurality of convex portions and a plurality of concave portions on at least one surface of the internal electrode, and the printing of the internal electrode pattern is performed so that the convex and concave portions extend in a first direction, respectively, and are alternately disposed.

### BRIEF DESCRIPTION OF DRAWINGS

The above and other aspects, features and other advantages in the present disclosure will be more clearly understood from the following detailed description taken in conjunction with the accompanying drawings, in which:

FIG. 1 is a partially cut-away perspective view schematically illustrating a multilayer ceramic electronic component according to an embodiment in the present disclosure;

FIG. 2 is a cross-sectional view taken along line A-A′ of FIG. 1;

FIG. 3 is a perspective view schematically illustrating internal electrodes of the multilayer ceramic electronic component according to an embodiment in the present disclosure;

FIG. 4 is a cross-sectional view taken along line B-B′ of FIG. 3;

FIG. 5 is a cross-sectional view taken along line C-C′ of FIG. 3; and

FIG. 6 is a flow chart illustrating a method of manufacturing a multilayer ceramic electronic component according to another embodiment in the present disclosure.

### DETAILED DESCRIPTION

Exemplary embodiments in the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Multilayer Ceramic Electronic Component

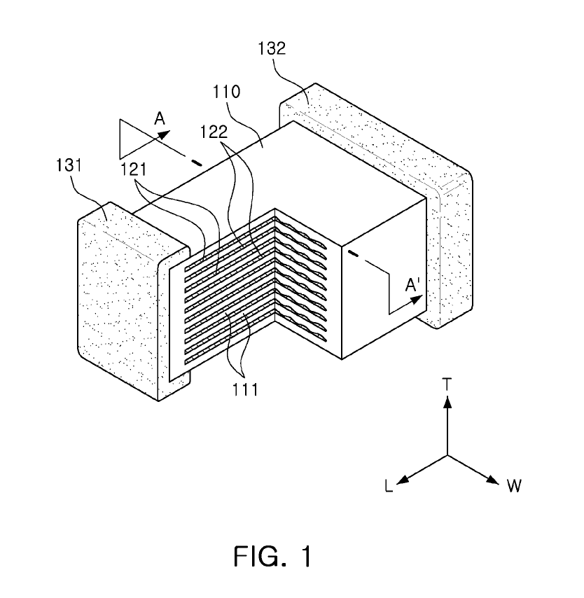

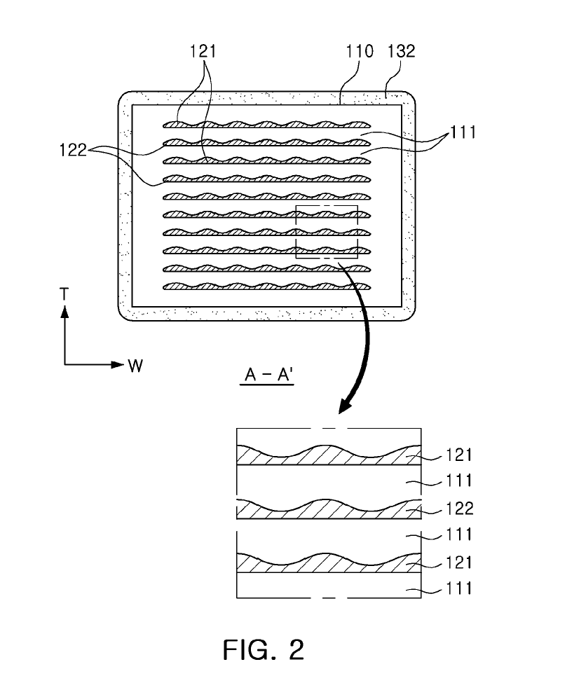

FIG. 1 is a perspective view schematically illustrating a multilayer ceramic electronic component according to an embodiment in the present disclosure, and FIG. 2 is a cross-sectional view taken along line A-A′ of FIG. 1.

Referring to FIG. 1, the multilayer ceramic electronic component 100 according to an embodiment in the present disclosure may include a ceramic body 110; and external electrodes 131 and 132.

According to an embodiment in the present disclosure, a T-direction illustrated in FIGS. 1 and 2 refers to a thickness direction of the ceramic body 110, an L-direction refers to a length direction of the ceramic body 110, and a W-direction refers to a width direction of the ceramic body 110.

The thickness (T) direction refers to a stacking direction of internal electrodes and dielectric layers.

Referring to FIGS. 1 and 2, the ceramic body 110 may have upper and lower surfaces opposing each other in the thickness direction, first and second side surfaces opposing each other in the width direction, and first and second end surfaces opposing each other in the length direction. A shape of the ceramic body 110 is not particularly limited. For example, the ceramic body 110 does not have a perfect hexahedral shape but may have a substantially hexahedral shape.

The ceramic body 110 may include a plurality of dielectric layers 111 and internal electrodes 121 and 122.

The ceramic body may include the internal electrodes 121 and 122 formed on the dielectric layers 111 and include an active part in which a plurality of dielectric layers including the internal electrode formed thereon are stacked and a cover part disposed on upper and lower portions of the active part.

Unless otherwise described, the upper and lower portions and the upper and lower surfaces are not distinguished in the ceramic body, but may indicate one portion and the other portion in the thickness direction and one surface and the other surface opposing each other in the thickness direction, respectively. In addition, the upper and lower surfaces may indicate first and second main surfaces opposing each other in the thickness direction of the ceramic body, respectively.

The internal electrode may include the first and second internal electrodes 121 and 122. The first and second internal electrodes 121 and 122 may be alternately disposed on the dielectric layer with each of the dielectric layers 111 interposed therebetween.

The first internal electrode 121 may be exposed to the first end surface of the ceramic body, and the second internal electrode 122 may be exposed to the second end surface of the ceramic body.

The external electrodes 131 and 132 may be disposed on the first and second end surfaces of the ceramic body to thereby be connected to the first and second internal electrodes 121 and 122. The external electrodes 131 and 132 may include the first external electrode 131 and the second external electrode 132, and the first external electrode 131 may be connected to the first internal electrode 121, and the second external electrode 132 may be connected to the second internal electrode 122.

The external electrode may be formed by applying a conductive paste to the first and second end surfaces of the ceramic body to then be sintered, but a shape and a method of forming the external electrode are not particularly limited.

According to an embodiment in the present disclosure, the dielectric layers 111 and the internal electrodes 121 and 122 may be stacked in the thickness (T) direction of the ceramic body as illustrated in FIG. 2.

Referring to FIG. 2, according to an embodiment in the present disclosure, the internal electrodes 121 and 122 may be formed so as to have an unevenness portion on at least one surface thereof.

The ceramic body 110 may be formed by sintering a green sheet multilayer body in which green sheets on which an internal electrode paste is printed and green sheets on which the internal electrode paste is not printed are stacked. The green sheet may contain dielectric powder configuring the ceramic body and a binder binding dielectric powder particles and further contain other additives, and the like. The binder may contain a resin composition such as an epoxy resin. The internal electrode paste may contain a metal powder, a binder, or other organic ingredients.

The organic ingredient contained in the green sheet or the internal electrode paste, which is an ingredient to be removed at the time of sintering the green sheet multilayer body, may be bonded to oxygen during a sintering process to hereby be discharged to the outside in a form of carbon dioxide (CO₂), or the like.

However, in the case in which the dielectric layer and the internal electrodes are formed using a paste containing a fine powder, the organic ingredient that needs to be removed during the sintering process of the ceramic body is not smoothly removed, but may remain in the ceramic body as residual carbon.

In the case in which the organic ingredient existing in the dielectric layer 111 and the internal electrodes 121 and 122 is not discharged to the outside of the ceramic body but remains in the ceramic body 110 as the residual carbon, long-time reliability of the multilayer ceramic electronic component may be decreased due to the occurrence of electrical degradation of the multilayer ceramic electronic component, or the like.

According to an embodiment in the present disclosure, the internal electrodes 121 and 122 may be formed so as to have the unevenness portion on at least one surface thereof. In the multilayer ceramic electronic component according to an embodiment in the present disclosure, the internal electrodes 121 and 122 are formed to have an unevenness portion having regularity on at least one surface thereof, such that the organic ingredient may be easily discharged during the sintering process of the ceramic body, thereby decreasing an amount of residual carbon in the ceramic body 110.

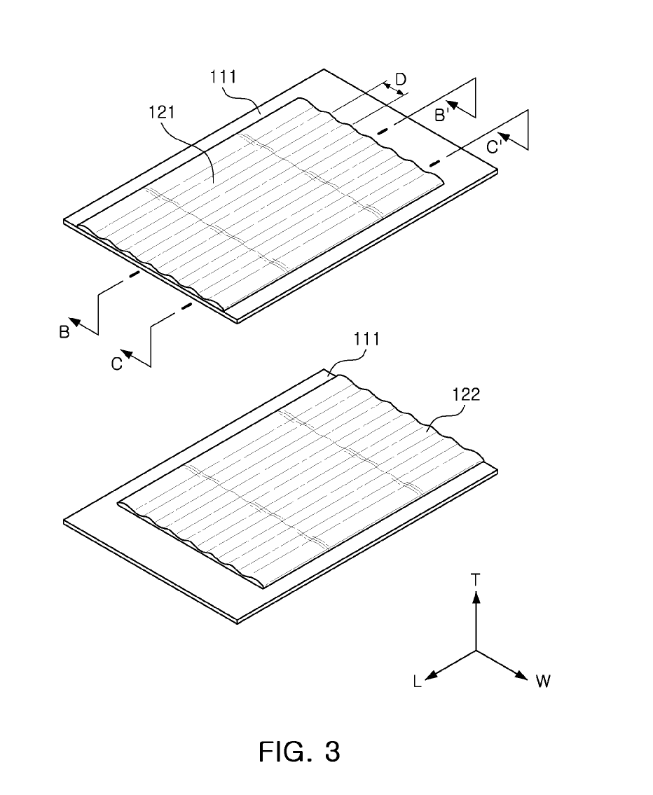

FIG. 3 is a perspective view schematically illustrating the internal electrodes 121 and 122 of the multilayer ceramic electronic component according to an embodiment in the present disclosure.

As illustrated in FIGS. 2 and 3, according to an embodiment in the present disclosure, the unevenness portion of the internal electrodes 121 and 122 includes a plurality of convex portions and a plurality of concave portions that are alternately disposed. The convex and concave portions may be formed to extend in a first direction, respectively, and may be alternately disposed in a second direction perpendicular to the first direction.

The first and second directions may be directions perpendicular to the thickness direction of the ceramic body.

According to an embodiment in the present disclosure, the first direction may be the length (L) direction of the ceramic body, and the second direction may be the width (W) direction of the ceramic body.

In the case of internal electrodes of a general multilayer ceramic electronic component, upper and lower surfaces thereof may be formed to be flat or may be formed to have fine unevenness portion irregularly formed due to particle distribution of metal powder particles contained in an internal electrode paste.

However, in the multilayer ceramic electronic component 100 according to an embodiment in the present disclosure, the internal electrodes 121 and 122 include the convex and concave portions formed to extend in the first direction, such that a carbon ingredient may be smoothly discharged during the sintering process of a multilayer ceramic body, thereby decreasing the amount of residual carbon in the ceramic body 110.

According to an embodiment in the present disclosure, in the unevenness portion of the internal electrodes 121 and 122, the concave portion may serve as a discharge path of residual carbon. For example, during a sintering process of the green sheet multilayer body, the concave portion may be a path through which oxygen is supplied to the interior of the green sheet multilayer body and a path through which carbon bonded to oxygen is discharged as carbon dioxide (CO₂).

According to an embodiment in the present disclosure, the dielectric layer 111 disposed on the surfaces of the internal electrodes 121 and 122 having the unevenness portion and the concave portions of the internal electrode may not entirely closely adhered to each other, and gaps may be formed therebetween. The gaps may be locally or partially formed in a region in which the concave portions and the dielectric layer face each other.

According to an embodiment in the present disclosure, the convex and concave portions of the internal electrodes 121 and 122 may be formed to be parallel with the length direction of the internal electrodes, and one ends thereof may be exposed to an outer surface of the ceramic body 110, such that the organic ingredient in the ceramic body may be more efficiently discharged to the outside of the ceramic body. The convex and concave portions may be formed in parallel with each other.

Referring to FIG. 3, according to an embodiment in the present disclosure, an interval D between peaks of adjacent convex portions in the unevenness portion of the internal electrodes 121 and 122 may be 30 μm or more. In a case in which the interval between the peaks of the convex portions is less than 30 μm, a degree of electrode flatness of the internal electrodes 121 and 122 in the width direction may be decreased, such that reliability may be deteriorated.

According to an embodiment in the present disclosure, a difference between electrode connectivity measured at peaks of the convex portions of the internal electrodes 121 and 122 and electrode connectivity measured in troughs of the concave portions of the internal electrodes 121 and 122 may be 3 to 12%.

For example, when the electrode connectivity measured at the peaks of the convex portions of the internal electrodes 121 and 122 is defined as E1, and the electrode connectivity measured in the troughs of the concave portions of the internal electrodes 121 and 122 is defined as E2, 3%≦E1-E2≦12% may be satisfied.

In the case in which the difference between the electrode connectivity measured at the peaks and in the troughs of the internal electrodes is less than 3%, removal efficiency of a carbon ingredient in the ceramic body may not be improved, such that reliability may be deteriorated due to residual carbon in the ceramic body, and in the case in which the difference between the electrode connectivity measured at the peaks and in the troughs of the internal electrodes is more than 12%, electrode flatness may be decreased, and average electrode connectivity at the concave portion may be deteriorated, such that a breakdown voltage (BDV) may be decreased.

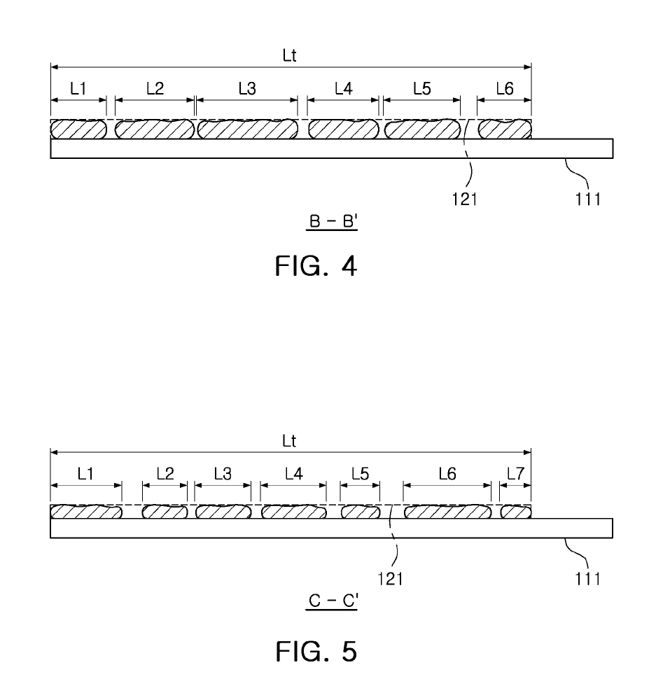

FIG. 4 is a cross-sectional view taken along line B-B′ of FIG. 3, and FIG. 5 is a cross-sectional view taken along line C-C′ of FIG. 3. B-B′ corresponds to the peaks of the convex portions of the internal electrode and C-C′ corresponds to the troughs of the concave portions of the internal electrode.

A method of measuring electrode connectivity at the peaks and in the troughs of the internal electrodes 121 and 122 will be described with reference to FIGS. 4 and 5.

As illustrated in FIGS. 4 and 5, the electrode connectivity at the peaks of the internal electrodes 121 and 122 and the electrode connectivity in the troughs of the internal electrodes 121 and 122 may be defined as a ratio of ΣLn, which is a sum of entire lengths of regions in which the internal electrode is actually applied, to the entire length Lt of the internal electrode, which is a distance between both end portions of the internal electrode in the length direction, in cross-sections of regions corresponding to the peaks and troughs of the internal electrode, respectively, in a length-thickness direction (here, n is the number of regions in which the internal electrode is actually applied).

For example, the electrode connectivity at the peaks of the internal electrodes 121 and 122 may be measured by measuring a ratio of ΣLn (L1+L2+L3+L4+L5+L6), which is the sum of the entire lengths of the regions in which the internal electrode is actually applied, to the entire length Lt of the internal electrode, which is the distance between both end portions of the internal electrode in the length direction, in the cross-section of the region corresponding to the peaks of the internal electrode in the length-thickness direction as illustrated in FIG. 4.

For example, the electrode connectivity in the troughs of the internal electrodes 121 and 122 may be measured by measuring a ratio of ΣLn (L1+L2+L3+L4+L5+L6+L7), which is the sum of the entire lengths of the regions in which internal electrode is actually applied, to the entire length Lt of the internal electrode, which is the distance between both end portions of the internal electrode in the length direction, in the cross-section of the region corresponding to the troughs of the internal electrode in the length-thickness direction as illustrated in FIG. 5.

The entire length Lt of the internal electrode is a sum of lengths of the regions in which the internal electrode is actually applied and lengths of portions disconnected between the regions in which the internal electrode is actually applied. Pores or a ceramic material may be present in the portions disconnected between the regions in which the internal electrode is actually applied.

The electrode connectivity, which indicates an application rate of the internal electrode, may be defined as a ratio of length of actually disposed internal electrode to the entire length of the internal electrode in a cross section of the internal electrode.

According to an embodiment in the present disclosure, average electrode connectivity of the internal electrodes 121 and 122 may be 80% or more. The average electrode connectivity of the entire internal electrode may be defined as a number average value of the electrode connectivity measured at the peaks of the convex portions of the internal electrode and the electrode connectivity measured in the troughs of the concave portions of the internal electrode.

An average thickness of the internal electrodes 121 and 122 after sintering is not particularly limited as long as capacitance is formed. For example, the average thickness may be 0.65 μm or less.

The average thickness of the internal electrodes 121 and 122 may be measured from an image obtained by scanning a cross-section of the ceramic body 110 in a thickness-width direction using a scanning electron microscope (SEM).

For example, thicknesses at thirty points that are equidistant from one another in the width direction may be measured, with respect to the internal electrode randomly sampled from the image obtained by scanning a cross-section of the ceramic body 110 in a width-thickness (W-T) directions, taken along a central portion of the ceramic body 110 in the length (L) direction using the scanning electron microscope (SEM), thereby measuring a number average value.

The thirty points that are equidistant from one another may be designated so that the peaks and troughs of the surface of the internal electrode are alternately selected.

In addition, when an average thickness of ten or more internal electrodes is measured by the above-mentioned method, the average thickness of the internal electrodes may be further generalized.

Method of Manufacturing Multilayer Ceramic Electronic Component

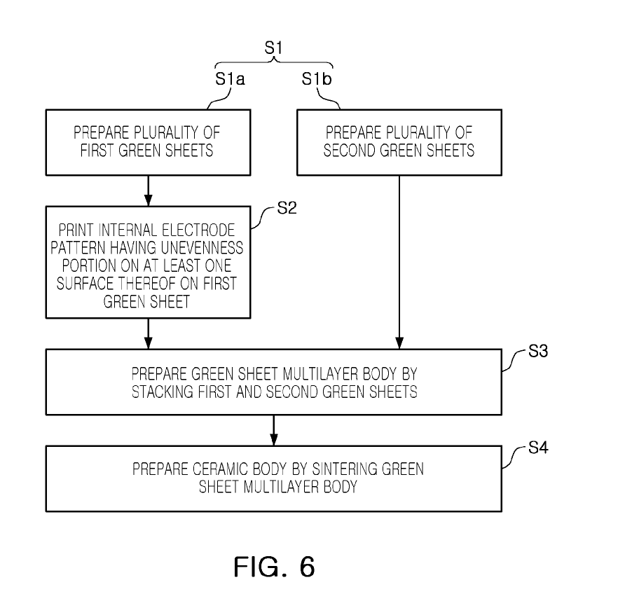

FIG. 6 is a flow chart illustrating a method of manufacturing a multilayer ceramic electronic component according to another embodiment in the present disclosure.

The method of manufacturing a multilayer ceramic electronic component according to the embodiment in the present disclosure may include preparing a plurality of first green sheets and a plurality of second green sheets (S1); forming an internal electrode pattern on the first green sheet (S2); preparing a green sheet multilayer body (S3); and preparing a ceramic body (S4).

Among descriptions of the method of manufacturing a multilayer ceramic electronic component according to the embodiment in the present disclosure, a description overlapped with that of the above-mentioned multilayer ceramic electronic component according to the foregoing embodiment in the present disclosure will be omitted, and a difference therebetween will be mainly described below.

The first green sheet is a green sheet on which the internal electrode pattern will be formed to form an active part (S1a), and the second green sheet is a green sheet for the formation of a cover part (S1b). Both of the first and second green sheets may be formed in plural, respectively.

The preparing of the plurality of ceramic green sheets (S1) may be performed by applying a slurry containing a dielectric powder to a carrier film to then be dried.

The forming of the internal electrode pattern (S2) may be performed by applying an internal electrode paste to the ceramic green sheet through a printing method, but a method of forming the internal electrode pattern is not limited thereto. The forming of the internal electrode pattern may be performed so that the internal electrode pattern has an unevenness portion on at least one surface thereof. The unevenness portion includes a plurality of convex portions and a plurality of concave portions that are alternately disposed, and the convex and concave portions may be formed to extend in a first direction, respectively.

The forming of the internal electrode pattern may be performed through a gravure method so that the internal electrode pattern has a regularly formed unevenness portion, and in the case of forming the internal electrode pattern using the gravure method, intervals and depths of the convex and concave portions of the internal electrode patterns may be adjusted by controlling cell arrangement, a printing speed, or the like.

The preparing of the green sheet multilayer body (S3) may be performed by stacking the first green sheet on which internal electrode pattern is formed and the second green sheet on which the internal electrode pattern is not formed.

The second green sheet may be stacked so as to be disposed on upper and lower portions of a region in which the first green sheets are stacked.

Next, the preparing of the ceramic body (S4) may be performed by sintering the green sheet multilayer body.

However, as necessary, before a sintering process, a process of compressing the green sheet multilayer body and cutting the compressed green sheet multilayer body into an individual chip form so that one ends of the internal electrode patterns are alternately exposed to cutting surfaces may be further included.

Subsequently, external electrodes may be formed by applying an external electrode paste to outer surfaces of the ceramic body to then be sintered. Application of the external electrode paste may be performed by dipping the ceramic body in the external electrode paste, but is not limited thereto.

### Experimental Example

The following Table 1 shows data obtained by evaluating long-term reliability and breakdown voltage (BDV) characteristics depending on a difference between electrode connectivity measured at peaks of an internal electrode and electrode connectivity measured in troughs of the internal electrode.

A multilayer ceramic electronic component used in the present Experimental Example was manufactured as follows.

A slurry containing a powder such as barium titanate (BaTiO₃) powder, or the like, was applied to a carrier film to then be dried thereon so as to prepare a plurality of ceramic green sheets.

Then, an internal electrode pattern was formed by applying a conductive paste for an internal electrode containing nickel on a portion of the ceramic green sheets by a gravure printing method.

The internal electrode pattern was formed so as to have a regularly formed unevenness portion, and convex and concave portions were formed so as to be parallel with a length direction of the internal electrode pattern.

The internal electrode pattern was variously formed so that the differences between electrode connectivity measured at the peaks and in the troughs of the internal electrode may have values as illustrated in the following Table 1.

Next, the ceramic green sheet on which the internal electrode pattern was printed and the ceramic green sheet on which the internal electrode pattern was not printed were stacked and isostatically pressed. The ceramic multilayer body subjected to the isostatic pressing was cut in the form of individual chips so that one ends of the internal electrode patterns were alternately exposed to cut surfaces, and the cut chip was subjected to a de-binding process.

Subsequently, a ceramic body was formed by sintering the chip under a reduction atmosphere having oxygen partial pressure lower than Ni/NiO equilibrium oxygen partial pressure so that the internal electrodes were not oxidized. After sintering, a size of the ceramic body was about 1.0 mm×0.5 mm×0.5 mm (length×width×thickness (L×W×T), 1005 size, error range: ±0.1 mm).

Here, an average thickness of dielectric layers included in a capacitance formation part was about 0.6 μm, an average thickness of the internal electrodes was about 0.5 μm, and the number of stacked internal electrodes was about 400.

Then, a paste containing a copper powder and glass frit was applied to outer surfaces of the ceramic body to which the internal electrodes were exposed, and the applied paste was sintered, thereby forming an external electrode layer.

At the time of evaluating long-term reliability, the case in which an IR drop occurred within 200 hours under high temperature and high pressure conditions was evaluated as bad, and the BVD was measured and indicated as a voltage when a leakage current occurred at the time of applying a voltage to the multilayer ceramic electronic component while increasing the voltage by 10V/sec.

TABLE 1

| | Difference (%) of Connectivity at | | |
|---|---|---|---|
| | Peaks and in Troughs of Internal | Long-Term | |
| Sample | Electrode | Reliability | BDV |
| 1* | 1 | X | ⊚ |
| 2* | 2 | X | ⊚ |
| 3 | 3 | ◯ | ⊚ |
| 4 | 4 | ◯ | ⊚ |
| 5 | 5 | ◯ | ⊚ |
| 6 | 6 | ◯ | ⊚ |
| 7 | 7 | ◯ | ◯ |
| 8 | 8 | ◯ | ◯ |
| 9 | 9 | ⊚ | ◯ |
| 10 | 10 | ⊚ | ◯ |
| 11 | 11 | ⊚ | ◯ |
| 12 | 12 | ⊚ | ◯ |
| 13* | 13 | ⊚ | X |
| 14* | 14 | ⊚ | X |

*indicates Comparative Example.
⊚: Excellent, long-term reliability defect rate < 0.1%, BVD ≧ 40 V
◯: Good, 0.1% ≦ long-term reliability defect rate < 1%, 20 V ≦ BVD < 40 V
X: Bad, long-term reliability defect rate > 1%, BVD < 20 V

Referring to Table 1, it may be appreciated that in samples 1 and 2 in which the difference between the connectivity at the peaks and in the troughs of the internal electrode was less than 3%, long-term reliability characteristics were not good, and in samples 13 and 14 in which the difference between the connectivity at the peaks and in the troughs of the internal electrode was more than 12%, the BDV was relatively low.

According to embodiments in the present disclosure, the multilayer ceramic electronic component in which the content of a residual organic ingredient in the ceramic body is relatively small and the method of manufacturing the same may be provided.

While embodiments have been shown and described above, it will be apparent to those skilled in the art that modifications and variations could be made without departing from the scope of the invention as defined by the appended claims.

What is claimed is:

1. A multilayer ceramic electronic component comprising:
a ceramic body including a plurality of dielectric layers; and
internal electrodes disposed on the dielectric layers and having an unevenness portion on at least one surface of the internal electrode,
wherein the unevenness portion includes a plurality of convex portions and a plurality of concave portions alternately disposed, the convex and concave portions extending in a first direction, respectively.

2. The multilayer ceramic electronic component of claim 1, wherein a difference between electrode connectivity measured at peaks of the convex portions and electrode connectivity measured in troughs of the concave portions is 3% to 12%.

3. The multilayer ceramic electronic component of claim 1, wherein an interval between peaks of adjacent convex portions in the unevenness portion is 30 μm or more.

4. The multilayer ceramic electronic component of claim 1, wherein average electrode connectivity of the internal electrode is 80% or more.

5. The multilayer ceramic electronic component of claim 1, wherein the convex and concave portions are parallel with each other.

6. The multilayer ceramic electronic component of claim 1, wherein the convex and concave portions are parallel with a length direction of the internal electrode.

7. The multilayer ceramic electronic component of claim 1, wherein an average thickness of the internal electrode is 0.65 μm or less.

8. A multilayer ceramic electronic component comprising:
a ceramic body including a plurality of dielectric layers; and
internal electrodes disposed alternately with the dielectric layers and having a plurality of convex portions and a plurality of concave portions on at least one surface of the internal electrode,
wherein the convex and concave portions are formed to be parallel with a first direction and are alternately disposed in a second direction perpendicular to the first direction.

9. A method of manufacturing a multilayer ceramic electronic component, the method comprising:
preparing a plurality of first green sheets and a plurality of second green sheets;
printing an internal electrode pattern having an unevenness portion formed on at least one surface of the internal electrode pattern on the first green sheet;
preparing a green sheet multilayer body by stacking the first and second green sheets; and
preparing a ceramic body including a plurality of dielectric layers and a plurality of internal electrodes by sintering the green sheet multilayer body,
wherein the internal electrode includes a plurality of convex portions and a plurality of concave portions on at least one surface of the internal electrode, and
the printing of the internal electrode pattern is performed so that the convex and concave portions extend in a first direction, respectively, and are alternately disposed.

10. The method of claim 9, wherein the printing of the internal electrode pattern is performed by a gravure printing method.

11. The method of claim 9, wherein the printing of the internal electrode pattern is performed so that a difference between electrode connectivity measured at peaks of the convex portions and electrode connectivity measured in troughs of the concave portions is 3% to 12%.

12. The method of claim 9, wherein the printing of the internal electrode pattern is performed so that an interval between peaks of adjacent convex portions of the internal electrode is 30 μm or more.

13. The method of claim 9, wherein the printing of the internal electrode pattern is performed so that average electrode connectivity of the internal electrode is 80% or more.

14. The method of claim 9, wherein the printing of the internal electrode pattern is performed so that the convex and concave portions are formed in parallel with each other.

15. The method of claim 9, wherein the printing of the internal electrode pattern is performed so that the convex and concave portions are formed in parallel with a length direction of the internal electrode.

16. The method of claim 9, wherein the printing of the internal electrode pattern is performed so that an average thickness of the internal electrode is 0.65 μm or less.
